(19) United States
(12) Patent Application Publication
(10) Pub. No.: US 2006/0191185 A1
(43) Pub. Date: Aug. 31, 2006

(54) Downrigger System with Responsive Depth Setting

(76) Inventor: Robert Magnus Hansen, Fairfax, VA (US)

Correspondence Address: HANSEN HUANG TECHNOLOGY LAW GROUP, LLP, 1725 EYE STREET, NW, SUITE 300, WASHINGTON, DC, 20006, US

(21) Appl. No.: 11/383,206

(22) Filed: May 14, 2006

(51) Int. Cl. A01K 91/08

(52) U.S. Cl. 43/27.4; 43/43.13

(57) ABSTRACT

A downrigger system for suspending a lure or bait at a depth during trolling includes a controller for adjusting the operating depth in response to detecting fish on a sonar or upon reaching a navigation waypoint entered in a GPS system. Information received from a sonar or a GPS receiver system are compared to preselected parameters to determine whether the operating depth of the downrigger weight should be adjusted. Sonar transducers or a reflector may be added to the weight to permit more accurate control of the operating depth. Fish attractors may be attached to the weight to take advantage of the weight being positioned at the depth of detected fish.

### FIELD OF THE INVENTION

The present invention relates to fishing and boating equipment, and more particularly to downrigger devices for adjusting the depth of a lure or bait attached to a fishing line in response to sensed conditions.

### BACKGROUND OF THE INVENTION

Downriggers are used by fishermen to position fishing lures and bait at a selected or variable depth while trolling and to hold the business end of the fishing line in the vicinity of that selected depth until a fish strikes the lure. Upon a strike occurring, the lure line is separated from a weight, which is used to hold the line at depth, and the fish is played on normal tackle. Typically, downriggers suspend lures and bait at a preset depth where fishermen expect to catch fish. This depth may be selected based upon the temperature profile of the water, or detection of fish by fish discriminating sonar. Another method of selecting the depth for downriggers is based upon an offset above the bottom at which fish are expected.

Typically when fishing, downriggers are set at a selected depth where the lure or bait remains until the downrigger is moved up or down by the fisherman. Fishermen may monitor a sonar device while trolling and raise or lower the downrigger to follow the bottom or try to intercept fish. In the presence of bottom contours and fish at unpredictable depths, raising and lowering the downrigger requires the fisherman's full attention to the downrigger control and the sonar display, preempting attention to controlling the boat, monitoring other fishing poles, or even just enjoying a day of fishing.

Some downriggers cyclically raise and lower the bait in an attempt to attract fish, such as disclosed in U.S. Pat. No. 4,974,358, which is hereby incorporated by reference in its entirety. Also, at least one manufacturer offers a bottom-following downrigger (see http://tackledirect.com/cannonmag20dt.html).

Thus, there exists a need for a downrigger system that helps fisherman to dynamically position lures and baits at the proper depth to catch fish without requiring constant attention of the fisherman.

### SUMMARY OF THE INVENTION

The present invention includes a system for maintaining a downrigger weight at a depth based upon a set depth entered by a fisherman, an offset to the bottom (bottom following) or water temperature while monitoring for the presence of fish at other depths or proximity to a Global Positioning System (GPS) waypoint for which the fisherman has set a preferred fishing depth. When fish are detected by a fish-finder sonar, the system automatically adjusts the depth of the weight to a pre-selected offset from the depth of the fish (e.g., a few feet above the level of the fish) so as to present the bait at a proper position with respect to the fish. Similarly, when the fisherman's boat approaches a location (waypoint) entered as one or more GPS coordinates where the fisherman has entered a pre-set depth, the system automatically adjusts the depth of the weight to the pre-set depth. Optionally, the system includes an alarm or enunciator that sounds to inform the fisherman when the system is raising or lowering the weight. As an additional option, the weight may be fashioned with fish attractors since its movement in the vicinity of fish may be use to attract the fish to the bait.

### BRIEF DESCRIPTION OF THE DRAWINGS

FIG. 1 is an illustration of an embodiment of the present invention.

FIG. 2 is a functional block diagram of an embodiment of the present invention.

FIG. 3 is an illustration of a system controller according to an embodiment of the present invention.

FIG. 4 is a process flow diagram of a main functional loop of an embodiment of the present invention.

FIG. 5 is a process flow diagram of a main menu routine of an embodiment of the present invention.

FIGS. 6 through 10 are process flow diagrams of subroutines of various embodiments of the present invention.

FIG. 11 is an illustration of a downrigger weight including a temperature sensor according to an embodiment of the present invention.

FIG. 12 is an illustration of a downrigger weight including sonar transducer assemblies according to an embodiment of the present invention.

FIG. 13 is an exploded view of example components of sonar transducer assemblies illustrated in FIG. 12.

FIG. 14 is an illustration of a downrigger weight including a sonar retro-reflector according to an embodiment of the present invention.

FIG. 15 is a process flow diagram for a subroutine for calibrating a downrigger depth indicator using sonar sensor data.

FIG. 16 is an illustration of a downrigger weight including a sonar reflector and fish attractors according to an embodiment of the present invention.

FIG. 17 is an illustration of a downrigger weight including a sonar reflector, fish attractors and a reservoir for releasing fish attractant according to an embodiment of the present invention.

### DETAILED DESCRIPTION

The present invention will be described in detail with reference to the accompanying drawings. Wherever possible, the same reference numbers will be used throughout the drawings to refer to the same or like parts.

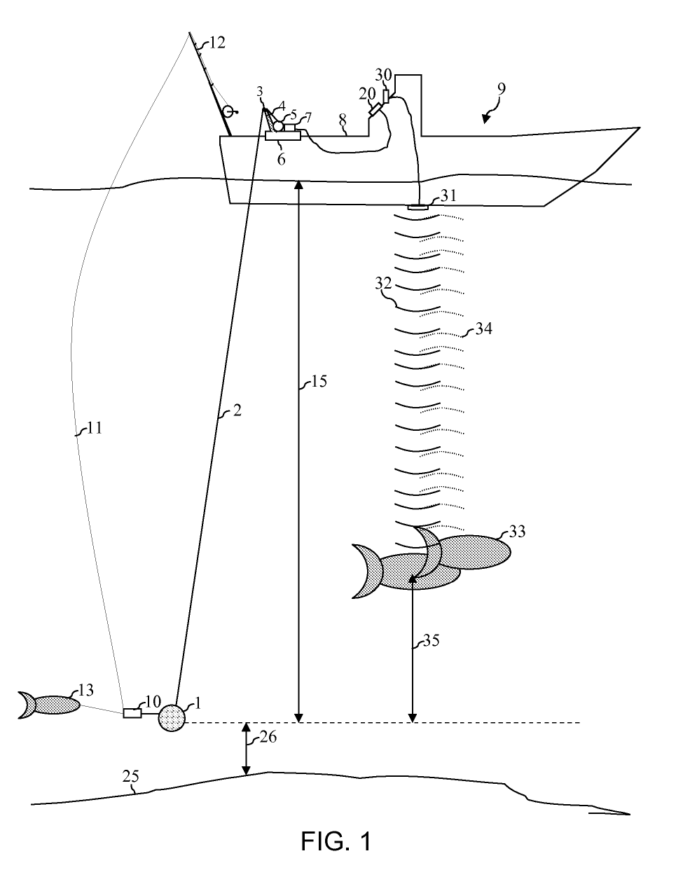

Referring to FIG. 1, a downrigger assembly features a weight 1, e.g., a lead or iron ball (sometimes referred to as a cannonball) or a dive plane (not shown) connected to a line, rope or wire 2 that passes over a pulley wheel 3 on the end of a stiff pole or boom 4 to a reel 5. A drive mechanism, such as a hand crank (not shown) or an electric drive assembly 7, coupled to the reel 5 permits the wire 2 to be played out or reeled in to control the depth 15 of the weight 1 beneath the boat 9. A clip 10 connected to the weight 1 is configured to hold onto a fishing line 11 and release the fishing line 11 when the lure or bait 13 is struck by a fish. A bracket 6 removably attaches the downrigger pole 4, reel 5 and drive mechanism 7 to the railing 8 of the boat 9. Alternative configurations for the clip 10 are well known, examples of which are illustrated in U.S. Pat. No. 4,173,091. The fishing line 11 extends from a fishing pole 12 and is releasably attached to the clip 10. Secured to the end of fishing line 11 is the lure or bait 13. In normal operation, the fisherman attaches the fishing line 11 to clip 10 when the weight 1 is in a near fully raised position. The reel 5 is then turned to reel out the downrigger line or wire 2 to position the weight 1 at the appropriate depth 15 for fishing. As shown in FIG. 1, lure or bait 13 will then be properly positioned at the desired depth 15 while trolling. When a fish takes the lure or bait 13, the fishing line 11 is pulled from the clip 10 so the fisherman can play the fish without the weight 1.

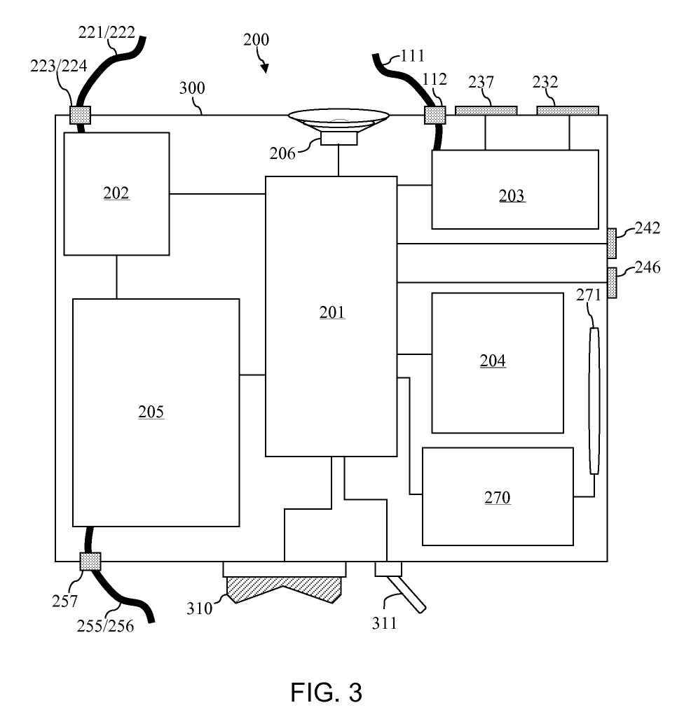

In addition to the physical assembly described above, a control assembly 20 is electrically connected to the electric drive assembly 7 to command the drive to reel in or play out the wire. In a conventional powered downrigger assembly, the electrical control 20 may be as simple as a three position switch: up (reel in); hold; or down (reel out). In the present invention, the electrical control 20 includes a three position switch 310 (FIG. 3) to permit direct control of the electric drive assembly 7 by the fisherman, but additionally includes a controller 200 configured and programmed to be capable of controlling the electric drive 7 and performing other functions described herein. Additionally, a sensor can be included in the assembly, such as an electrical contact, coupled to or part of the clip 10 that detects when the fishing line 11 is no longer in the clip 10 and sends a message to the downrigger control assembly 20. Alternatively, a sensor on the fishing pole 12 or pole holder may detect when a fish is on the line and send a message to the downrigger control assembly 20. Also, a button or switch can be included to permit the fisherman to signal to the downrigger control assembly 20 when a fish is on the line 11. In response to a signal that the fishing line 11 is no longer in the clip 10 (or that a fish is on the pole), downrigger control assembly 20 can direct the electric drive assembly 7 to turn the reel 5 so as to raise the weight 1 in order to allow the fisherman to play the fish without risk of tangling the fishing line 11 with the downrigger line or wire 2.

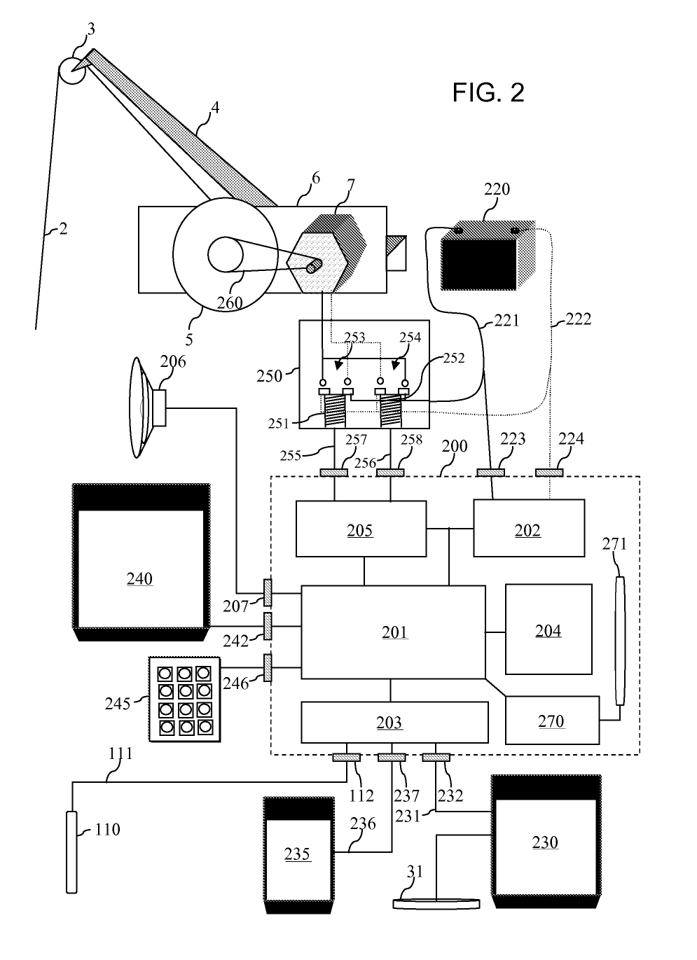

FIG. 2 illustrates a functional block diagram showing example components of the downrigger system according to various embodiments of the present invention. As discussed with respect to FIG. 1, the mechanical elements of the downrigger system include a reel 5 for taking up and letting out line or wire 2, a pole or boom 4 at the end of which may be a roller or pulley 3 for passing line over the side of the boat 9, a drive motor assembly 7 coupled to the reel 5, such as by a gear, chain or belt 260 mechanism, and a bracket assembly 6. The bracket assembly 6 (or assemblies) provides a mounting (or mountings) for the boom 4, reel 5 and drive motor assembly 7, as well as providing an attachment structure and/or mechanism for attaching the system to the boat 9.

The present invention includes a powered drive assembly 7, preferably an electric drive (i.e., electric motor) assembly, although the drive assembly may alternatively be hydraulic or internal combustion engine drives. In the electric drive embodiment, power for the electric motor 7 may be drawn from a dedicated power source, such as a lead-acid battery 220, or the batteries and/or alternator of the boat's motor or electrical system. Typically, such power sources or systems are 6, 12, 24 or 28 volts and capable of inducing large currents as required by engine starter motors. Therefore, there is a need to isolate the electrical power applied to the electric motor 7 of the downrigger drive assembly from the electronics of the controller 200 which controls the current applied to the electric motor 7. This may be accomplished by any of a number of electrical and electrical/mechanical relay circuits as are well known in the art. An example of such a relay circuit is shown as relay assembly 250, including two solenoid relays 251, 252, in order to illustrate how the high voltage, high power from the battery 220 is connected to the electric motor 7 by a relatively low voltage, low power control signal provided by the controller 200. While the relay assembly 250 is illustrated as including two solenoid relays 251, 252, a preferred embodiment of the present invention employs solid state power switching circuits or relays, e.g., employing high power transistor switches. A solid state relay eliminates the use of mechanical switches that may have lower reliability in a marine environment and greater susceptibility to corrosion from salt spray. As used herein, the term “control relay” refers to any mechanical or solid state switch suitable for switching the electric motor 7 “on” and “off” (i.e., connecting and disconnecting the motor to/from the high-power voltage source and controlling) and, in some configurations, controlling the direction of rotation in response to control signals from the controller 200.

Functionally, when the controller 200 sends an “up” control signal via control lead 255 to the control relay 250, the control signal causes relay 252 to actuate, closing a switch 254 that connects the positive lead 221 (for example) from the boat's electrical system or battery 220 to the first lead of the downrigger electric motor 7, and the negative (or ground) lead 222 to the second lead of the downrigger electric motor 7. Similarly, when the controller 200 sends a “down” control signal via control lead 256 to the control relay 250, the control signal causes relay 251 to actuate, closing a switch 253 that connects the positive lead 221 from the boat's electrical system or battery 220 to the second lead of the downrigger electric motor 7, and the negative (or ground) lead 222 to the first lead of the downrigger electric motor 7. This description of the connections and functions of the relays is provided as an example, and one of skill in the art will recognize that this configuration of the control relay 250 is but one of a number of alternative circuit configurations that will enable the controller 200 to control the electric motor 7. For example, the controller 200 may provide a control signal via a single control lead 255 (e.g., positive voltage to provide an “up” command and negative voltage to provide a “down” command). Further, the control relay 250 may be located at any position between the controller 200 and the electric motor 7, including, in a preferred embodiment, within the housing of the electric motor 7 or the bracket assembly 6.

Exemplary components of the control assembly 200 according to an example embodiment are illustrated in FIG. 2. The example embodiment illustrated in FIG. 2 includes a programmable processor 201, which may be a microprocessor, microcomputer or microcontroller as are well known in the art. The processor 201 may be coupled to a memory 204, data interface circuitry 203, electric drive controller circuitry 205, a speaker 206, a display 240, and a key pad 245, and receive power from a power conditioning circuit 202. Such exemplary components can individual circuits or microchips, or be integrated into a single large scale integrated circuit or a chip set comprising a few integrated circuits as is well known in the electronic arts.

The power conditioning circuit 202 is provided to condition electrical power provided to the controller 200 into the voltage and current required by the controller 200 components. For example, the power conditioning circuit 202 receives the 6, 12, 24 or 28 volt, high power from the battery 220 via electrical leads 221, 222 and outputs the low voltage (e.g., 5 volts) with current limitations appropriate for the electronics for the controller 200 components. The power conditioning circuit 202 may also include fault protections, such as over- or under-voltage and over-current protection circuits (e.g., fuses or circuit breakers).

The data interface circuitry 203 can include data formatting/translating circuits and other signal processing circuits suitable for coupling data signals provided by other digital or analog equipment, such as a sonar/fish finder system 230 and/or a GPS system 235 and/or a temperature sensor 110. The data interface circuitry 203 serves the functions of receiving data signals in electrical (e.g., voltage, impedance) and data formats compatible with the external systems and converting the signals into formats compatible with the processor 201. For example, data interface circuitry 203 may include data encoding and decoding circuits appropriate to the type of data cable employed for connecting the external systems to the controller 200, such as RS-232, USB, Fire Wire, or other data cable/transmission encoding standards well known in the art. The data interface circuitry 203 are optional, since some embodiments may not require data decoding, reformatting or conditioning, such as where data formats of the external systems are compatible with the processor 201 or the controller 200 components and functions are incorporated within a marine GPS receiver, sonar/fish finder and combined systems. Also, the data interface circuitry may be a wireless data link transceiver, such as a WiFi or Bluetooth transceiver that may couple external systems (e.g., GPS receiver 235 or sonar/fish finder system 230) to the controller 200 by a digital data link.

The memory 204 may be a separate memory unit or incorporated as part of the processor 205, and optionally—such as in integrated embodiments described below—shared with other systems. The memory 204 may be one or a combination of random access memory (RAM), nonvolatile RAM (e.g., Flash memory), read only memory, magnetic disc memory (e.g., a miniature hard drive memory), or other machine readable memory as are well known in the art or may be developed. The memory may also be part of a microcomputer memory or a memory unit of another system (e.g., GPS receiver 235 or sonar/fish finder system 230) connected to the controller 200. The memory 204 can be used to store software instructions, user operating settings (e.g., preset depths and menu selections) for the downrigger, user data, and data employed in the functions of the present invention. Among the user data that can be stored in memory 204 may be GPS waypoint coordinates and associated trolling depths for the GPS-waypoint depth routine described more fully herein.

The controller 200 may include an internal or external speaker 206 or enunciator. As described more fully herein, when the processor 201 directs the drive motor assembly 7 to raise or lower the weight in response to an automatic determination (i.e., not in response to a user command), the processor 201 may cause a sound to be generated by the speaker 206 to alert the fisherman. By sounding an alert, the controller 200 can inform the fisherman that the depth of the weight 1 is changing. This alert may then allow the fisherman to adjust the amount of line let out from the fishing pole 12 or anticipate a potential strike by a fish. Suitable alerts may be as simple as a beep or tone, such as one beep or tone for raising and two beeps or tones for lowering the weight. As another example, the speaker 206 may be used to generate synthesized speech to provide the fisherman with more information, such as an explanation for the depth change. Such information may be provided by the controller 200 via the speaker 206 in response to, for example, a detection of fish by the connected sonar/fish finder 230, the approach to a GPS-depth waypoint, or activation to return the weight 1 to the preset depth. The speaker 206 may be built into the controller 200 packaging as illustrated in FIG. 3, may be an external speaker or another speaker on the boat, such as a radio speaker or a speaker of the sonar/fish finder system 230.

As illustrated in FIGS. 2 and 3, data (e.g., bottom depth and depth and size of detected fish) from a sonar/fish finder system 230 may be conveyed to the controller 200 by a data cable 231 that can be connected via a data connector 232. Similarly, latitude and longitude data may be conveyed to the controller 200 by a data cable 236 that can be connected via data connector 237. Display data and commands from the controller 201 can be conveyed to a display 240 via a display cable connected to connector 242. Further, data and commands from a keyboard 245 may be conveyed to the controller 201 via connector 246. Alternatively, data from sonar or GPS may be conveyed to the controller 200 by wireless data link as described herein.

The display 240 can be used to display downrigger settings (e.g., depth) and to present a fisherman with menu options, described more fully herein, for selecting operational parameters for the downrigger system. The display may be any display known in the art, including by way of example but not by way of limitation, light emitting diodes, a liquid crystal display (LCD), and a cathode ray tube (CRT).

A data input device, such as a key pad 245, can be provided for use by a fisherman to respond to menu prompts to select operational options and to enter operational parameters. As discussed more fully herein, the menu options may allow the fisherman to enter via a key pad 245 the normal operating depth, an offset above the bottom, an offset above or below fish at which the weight should be positioned, GPS/depth waypoint data, and other parameters. In an embodiment, the display 240 may be a touch screen LCD and thus serve as both a data/menu display and key pad 245.

As illustrated in FIG. 2, connections between the controller 200 and various external equipment and elements of the system may be by means of cable connectors, such as waterproof connectors 112, 207, 223. 224, 232, 237, 242, 246, 257 and 258. These connectors may be any of a number of standard power and data connectors well known in the art for providing reliable electrical connections and a moisture proof seal. Alternatively, as mentioned above, the connections between the controller 200 and various external equipment and elements of the system may be wireless data transceivers (e.g., a WiFi or Bluetooth transceiver), in which case one or more of components 112, 207, 223. 224, 232, 237, 242, 246, 257 and/or 258 would be such a transceiver.

Also illustrated in FIG. 2 is an optional wireless data communication transceiver circuit 270 and an associated antenna 271 that may be included within the controller 200 to provide a fisherman with a remote control capability. Such a wireless transceiver may be any radio frequency or infrared (IR) data communication system as are well known in the art. For example, the wireless transceiver circuit 270 may be a WiFi, Bluetooth, FM or AM transmitter/receiver employing a built-in antenna 271, or may be an IR transceiver (not shown) similar to wireless controllers used with televisions. An IR wireless communication link would employ an IR sensor with an IR transparent window in the housing 300 (as illustrated in FIG. 3). The option of a wireless data transceiver 270 allows a fisherman to use a wireless controller (not shown) to control various functions of the downrigger remotely. This may be advantageous when the fisherman is busy fighting a fish away from the control console or across the boat from the downrigger assembly. For example, the fisherman may use a remote to raise the downrigger if a fish is hooked on another pole in order to position the weight and attached fishing line and bait out of the way. Alternatively, the fisherman may use a remote to adjust the trolling depth without having to leave the fighting deck. As another example use of a downrigger remote control, the fisherman may override, disable or preempt the fish following or GPS waypoint depth operations, or alternatively, re-enable one or both of these operational options.

Three other embodiments of the present invention feature integration of the aforementioned system components and functionality within those of (1) a GPS receiver system 235, (2) a sonar/fish finder system 230, and (3) a combined GPS receiver/sonar system (not shown). In these embodiments, the components illustrated in FIGS. 2 and 3 can be included within the same housing of the system, and software functionality can be included within software of the system.

For example, typical marine GPS receivers, sonar/fish finders and combined systems include a programmable processor (e.g., a microprocessor), memory, and power conditioning components, as well as a display (typically an LCD display), a command/data entry keypad or keyboard and a speaker or enunciator that can easily be modified (e.g., by providing additional software routines for the processor according to embodiments described herein) to provide the aforementioned functionality of the present invention. Thus, in an integrated system according to one of the embodiments, additional software would be implemented on the system processor, and stored in memory, for implementing some or all of the downrigger processes and methods described herein. In the integrated embodiments, data from the GPS receiver or sonar/fish finder memory would be available in memory registers addressable by the processor. Such an integrated system embodiment may also include an input 112 for a water temperature sensor 110 or use water temperature information obtained by the sonar/fish finder system. A relay 250 or digital switch 205 is included to provide an electrical control interface between the low voltage/low current circuitry of an integrated GPS and/or sonar/fish-finder and downrigger controller on one side of the digital switch 205 and the relatively high voltage/high current drive motor assembly on the other side of the witch. The relay 250 or digital switch 205 can be configured as part of the drive motor assembly and configured to receive control signals from the integrated system via a data cable or a wireless data link such as described herein.

Included within the software implemented in any one of the integrated embodiments described above may be software to control the display in order to provide information and data/command entry menus associated with the downrigger control functions. For example, the downrigger menu displays described more fully herein may be presented on the same screen as used to display GPS, map and/or sonar information. Similarly, the displays for GPS, map and/or sonar information may include a window or portion displaying additional data associated with the downrigger functions described herein. Such information displays may include, for example, the current depth of the downrigger weight 1, the set operating depth, the operating depth offset from the bottom, the depth offset from detected fish, an identifier of a present GPS waypoint, and an indicator of the downrigger operating mode or modes selected and/or presently active.

Referring to FIG. 3, which illustrates a control assembly 200 according to an embodiment, the electronics for controlling the downrigger may be contained within a housing 300, which preferably is water-proof to protect the electronics from salt and moisture of the marine environment. The housing 300 may also include shock mountings (not shown) for the electronics since boats powering over waves can subject equipment to large periodic shocks. Alternatively, the control assembly may be built into the housing for another marine equipment, such as a housing containing electronics for the sonar/fish finder system 230, GPS receiver 235 or other boat electronics.

Within the housing 300 may be the processor 201, memory 204, data interface circuitry 203, power supply or power conditioning circuits 202, electric drive controller circuit 205, and speaker 206, buzzer or other enunciator. The housing 300 may also include a three-position switch 310 coupled to the processor 201 for manually controlling the downrigger drive (e.g., for selecting up, hold and down functions), and an on/off switch 311 for turning the system on and off. Alternatively, the switch may be remote, such as on the boat's console, and connect to the housing 300 by electrical wires.

In order to maintain the moisture-proof integrity of the housing 300, the assembly may also include electrical interface sockets 232, 237, 242, 246 and cable seals 112, 223, 224, 257. Electrical interface sockets 232, 237, 242, 246 are preferably standard electrical interface sockets (e.g., RS-232, USB, Fire Wire, and other standards as will be developed) to allow the use of standard data cable and connectors. The electrical interface sockets 232, 237, 242, 246 may be sealed into the housing 300 to form a moisture proof seal and to allow easy connect/disconnect of data cables to attached sensors as described above with respect to FIG. 2. Alternatively or in addition, some cables, such as power 221, 222 and control cables 255, 256 may penetrate the housing 300 through cable seals 223, 224, 255, 256. In FIG. 3, power cables 221 and 222, and control cables 255 and 256 are illustrated as a single two-conductor cable, although separate wires may be used with cable seals associated with each cable penetration of the housing 300.

Also illustrated in FIG. 3 is an optional wireless data communication transceiver circuit 270 and antenna 271. In order to minimize effects of the marine environment, the antenna 271 may be mounted within the housing 300 as illustrated. Alternatively, the antenna may be integrated into the exterior of the housing 300 or located outside the housing 300. Also, an optional wireless data communication transceiver circuit 270 may comprise an IR sensor 272, in which case the IR sensor 272 may be mounted behind a IR-transparent window 273 in a wall of the housing. The configurations shown for transceiver circuit 270 and antenna 271 are also illustrative of wireless data communications transceivers that may be used for connecting to and exchanging data with external systems, e.g., a GPS receiver 235 and/or a sonar/fish finder system 230.

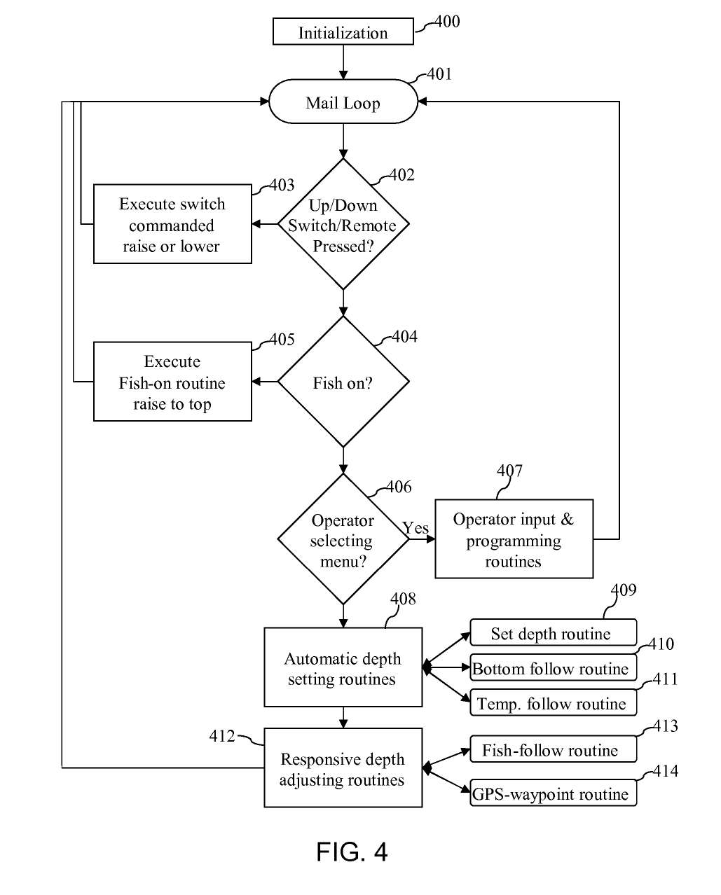

The functionality of various components of the system and methods of the present invention are now described with reference to the process flow diagrams illustrated in FIGS. 4 through 10. The following processes and methods can be implemented partially or entirely in software, firmware and circuitry as would be understood by one of skill in the art. Further, the following processes are examples of functional steps that may be implemented to accomplish the methods of the present invention. Thus, the following processes are described by way of example, not by way of limitation. The following processes include three depth setting routines and two depth diverting routines; however, additional routines may be added and are contemplated as part of the present invention.

The three illustrated depth setting routines are: (1) a single preset depth; (2) bottom-following at a selected offset (distance above the bottom); and (3) temperature-following. Operating the weight at a single preset depth is the typical operation of prior art downriggers; the fisherman merely selects a depth at which the bait or lure is to be maintained. The bottom following operational routine maintains the weight 1, and thus the bait or lure, at a selected offset distance above the bottom. This option may be advantageous when trolling for fish that linger near the bottom, such as striped bass. The temperature following operational routine maintains the bait or lure at depths where the water temperature is within a selected band of temperatures (i.e., between a maximum and a minimum temperature). This option may be advantageous when trolling for fish that seek out such temperatures or when thermoclines tend to attract bait fish.

The two depth diverting routines are referred to herein as fish-following and GPS-waypoint depth operations.

In the fish-following operational option, the downrigger will move the weight 1 up or down to present the bait or lure at a selected offset from (above, at, or below) the depth of fish detected by a sonar/fish finder system. If fish appear on the sonar at a depth different from the currently set depth (i.e., the depth setting per one of the three depth setting routines described above), the system operates to move the weight 1 up or down so that the bait will be presented at the selected offset from the fish, such as to present the bait so it can be best seen by the fish. Since some fish tend to look up or down when hunting for food, the fisherman is able to select an offset so as to present the bait or lure at the optimum position to be seen by the fish. For example, striped bass look up for bait fish, and accordingly, an offset of about 6 feet above the depth of fish may be selected to present the bait or lure at an optimum depth.

In the GPS-waypoint depth operational option, the system determines when the boat is approaching (e.g., within a preselected threshold distance of) a preset geographic location, referred to herein as a GPS waypoint, for which the fisherman has previously entered a particular desired trolling depth, and operates to position the weight 1 at the selected depth. This option can be advantageous when the fisherman identifies (e.g., by means of a GPS receiver) particular locations where fish tend to gather at particular depths. This may occur near sudden changes in bottom contours, near reefs, wrecks or other features on the bottom, or near bottom features that result in upwelling or inflow of nutrients or baitfish. In order to help fishermen record waypoints and depth settings, an operational menu routine may be included to allow fishermen to record GPS coordinates and trolling depth when fish are caught simply by pressing one or a few buttons. This operational option allows fishermen to return in the future to the same location and automatically position bait at the same depth at which they previously caught fish.

Typically, software programs implemented in processors associated with electronic systems include a main loop that is repeatedly performed and from which a number of functional routines are called. A typical main loop will check many status and interrupt flags (e.g., single stored bits of either “1” or “0”), and call functional routines based upon such flags, as well as perform necessary routine functions. Accordingly, the methods and routines of various embodiments are described herein within the context of such a main loop and called-routine software architecture. However, other software architectures may be used in other embodiments to implement the methods and routines of the present invention.

FIG. 4 illustrates a subset of functions that may be performed in the main loop of a system according to an embodiment. Upon start up, an initialization routine 400 may be performed to reset memory, set flags and perform other initializing steps necessary for operations to begin. Following initialization, main loop operations 401 begin. Within the main loop there may be an up/down switch position test 402 of an interrupt or status flag that indicates whether the up/down switch 310 is pressed. If such an interrupt flag is set, then the switch command routine 403 is performed, which sends a command signal to the control relay 250 to cause the electric motor 71 within the drive assembly 7 to raise or lower the weight 1 as indicated by the switch 310 position.

If the up/down switch interrupt flag is not set (so the up/down switch position test 402 is negative), as is the case when the switch 310 is in the neutral position, then the main loop may check the status of a “fish on” interrupt flag, step 404. In this test, the main loop checks a flag which is set by the system when a fish strike has removed the fishing line 11 from the line release 10. The “fish on” status flag may be set in response to any of (1) a sensor within the line release 10 sending a signal to the controller 200, (2) a sensor on the fishing pole 12 or (3) in a rod holder detecting the tension of a fish on the line, or (4) a manual action by the fisherman, such as by pressing a remote control button, pressing a button on the downrigger or pressing a button on the system housing 300. If the “fish on” status flag is set (e.g., a “1” is stored in the associated flag memory location), the fish on routine may be executed, step 405, in which the processor 201 sends a command signal to the control relay 250 or on the drive assembly 7 to cause the downrigger to raise the weight 1 to the full up position. In an embodiment, this routine commands the control relay 250 or drive assembly 7 to cause the downrigger to raise the weight 1 at a fast speed so as to remove the weight from the water before it fouls the fishing line 11.

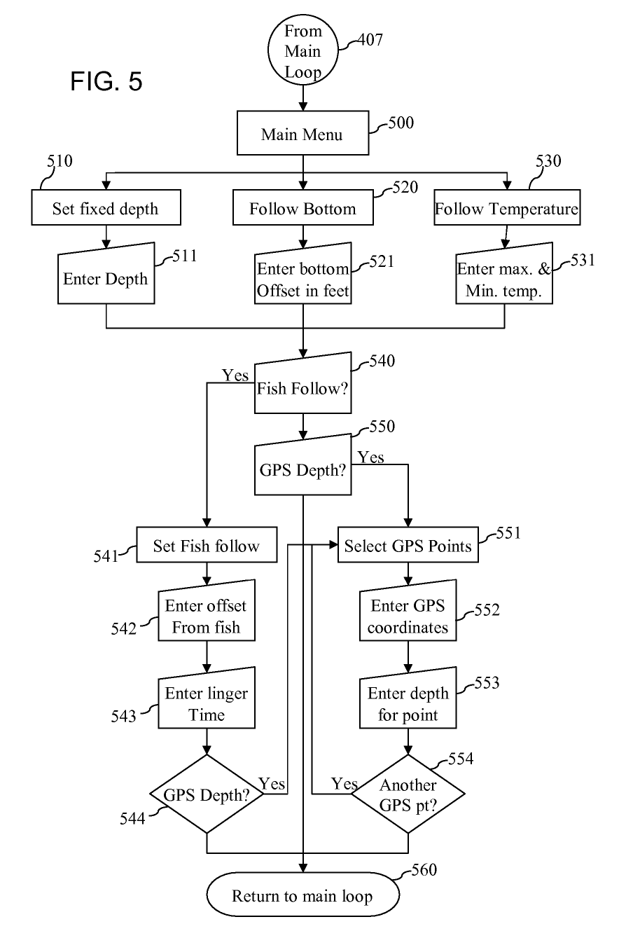

If neither of the up/down switch flag or “fish on” flag is set, then the main loop may test, in step 406, an interrupt flag that indicates whether an operator is attempting to enter the menu routine. When an fisherman presses a key or a “menu” button on the key pad 245 (or presses an indicated portion of a touch screen display), an interrupt flag may be set, which when checked in step 406 causes the processor 201 to execute the operator input and programming menu routines, step 407. The menu routine is described herein with reference to FIG. 5.

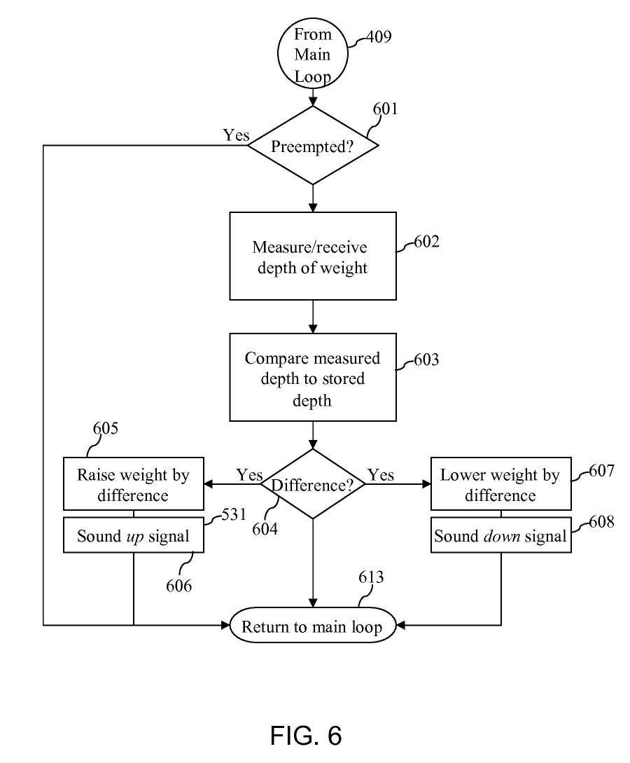

If a menu flag is not set, the main loop may then execute the automatic depth setting routines, step 408. In this step 408, the processor may check memory flags to determine which of various automatic depth setting routines are currently selected by the fisherman, and then initiate the appropriate routine based on the memory value. Such automatic depth setting routines may include routines for maintaining the weight 1 at a set depth, step 409, maintaining the weight at an offset above the bottom (i.e., the bottom-following routine), step 410, maintaining the weight 1 at depths determined by the temperature of the water, step 411. These depth setting routines are described in more detail below with reference to FIGS. 6, 7 and 8, respectively.

Following or before the automatic depth setting routines of step 408, the main loop may execute responsive depth adjusting routines 412, which are routines that preempt the aforementioned depth setting routines to change the depth of the weight 1 in response to inputs from other sensors. Preferably, the responsive depth adjusting routines include the fish-follow routine 413 and the GPS-waypoint depth routine 414 described more fully herein. In step 412, system flags may be checked to determine whether any or all of the responsive depth adjusting routines have been selected and are active. If a responsive depth adjusting routine is active, then the associated routine is activated. If no responsive depth adjusting routine is active, the remainder of the main loop is performed.

The main loop may include additional functions for operating the system as would be understood by one of skill in the art. Among the additional functions may be generation of a normal operations screen for presentation on the display 240 of status information as described herein, testing for faults, checking for shutdown or reset flags, and clock and memory maintenance functions.

At the conclusion of the main loop, which may include additional functions beyond those illustrated in FIG. 4, the software returns to the beginning of the loop 401 and repeats the aforementioned tests. By repeatedly cycling through the main loop rapidly, the system will respond promptly to any of the operator selections, “fish on” status or depth setting status indications (e.g., a change in the depth of the bottom or detection of fish by the sonar/fish finder system).

In performing the various menu embodiments, the main loop can continue to function so that the system continues monitoring for and responding to actuation of the up/down switch, “fish-on” status or changes (e.g., bottom or temperature readings) requiring depth adjustments according to current operational selection even while the fisherman is making menu selections and entering operational parameters.

If the test in step 406 determines that a menu flag is set, the menu routine call 407 will be performed in order to initiate a menu routine, such as the example illustrated in FIG. 5. In the menu routine, a main menu may be presented on the display 240 in step 500. This menu can present to the fisherman a number of options from which to choose, such as to set a fixed operating depth 510, select the bottom-following operation 520, or select the temperature profile following operation 530. These three depth setting routine options may be presented as menu options that can be selected by entering a number on the key pad 245, pressing a menu icon on a touch screen or selecting an icon with a pointing device (e.g., a mouse).

If the fisherman selects the option of setting a fixed depth 510, the processor 201 may then display a submenu prompting the fisherman to enter the desired operating depth, step 511. The fisherman may enter this value by keying in a number on the key pad 245 or on a touch screen display, or using a pointing device to select or indicate a desired depth, and then pressing an “enter” or “select” key or icon. The system then stores the entered depth data in memory 204. Once the operating depth is selected, the menu routine may then present a subsequent menu screen, such as to implement the fish-follow operational option 540, which is described below.

If the fisherman selects the option of initiating the bottom following operational option 520, the processor 201 may display a submenu in step 521 prompting the fisherman to enter the offset from the bottom (i.e., the distance above the bottom) that the downrigger should maintain the weight 1. As with other menu items, the fisherman may enter this value by keying in a number on the key pad 245 or on a touch screen display, or using a pointing device to select or indicate a desired offset from the bottom, and then pressing an “enter” or “select” key or icon. In the embodiments in which the downrigger components and functions are integrated with a sonar/fish finder system, particularly such systems which provide a display of fish and the bottom, the entry of the desired offset value may be entered by touching a touch screen or pointing to and clicking with a pointing device to a position above an indication of the bottom on the screen, which prompts the system to recognize the offset information, determine the corresponding distance and save the related data in memory 240. Once the offset value is entered, the menu routine may then present a subsequent menu screen, such as whether to implement the fish-follow operational option 540, which is described below.

If the fisherman selects the option of setting the operating depth to maintain the weight within a water temperature profile, step 520, the processor 201 may display a submenu prompting the fisherman to enter the maximum and minimum temperatures within which it is desired to operate the weight 1, step 531. The fisherman may enter these values by keying in numbers on the key pad 245 or on a touch screen display, or using a pointing device to select or indicate the temperature profile to follow, and then pressing an “enter” or “select” key or icon. The system then saves the temperature profile data in memory 204 for use in the depth setting routine. Once the desired operating temperature profile is selected, the menu routine may then present a subsequent menu screen, such as whether to implement the fish follow operational option 540, which is described below.

In the embodiment illustrated in FIG. 5, once a main depth setting routine is selected, a fish follow menu screen 540 may be displayed allowing the fisherman to initiate the fish-follow routine. If selected, such as by pressing a key, touching an icon on a touch screen or selecting an icon with a pointing device, a memory flag may be set in step 541 indicating that the fish following option has been selected, and a submenu may be displayed prompting the fisherman to enter the offset from the depth of the detected fish (i.e., the distance above or below the depth at which fish are detected) that the downrigger should maintain, step 542. The fisherman may enter this value by keying in a number on the key pad 245 or on a touch screen display, or using a pointing device to select or indicate a desired offset value, and then pressing an “enter” or “select” key. In the embodiments in which the downrigger components and functions are integrated with a sonar/fish finder system, particularly systems that provide a display of fish and the bottom, the entry of the desired offset value may be entered by touching a touch screen or pointing to and clicking with a pointing device to a position at, above or below an indication of fish on the screen, which prompts the system to recognize the offset information, determine the corresponding distance and save the related data in memory 240.

Once the offset value is entered, a linger time submenu 543 may be displayed prompting the fisherman to enter the time duration that the weight 1 should linger at the fish-follow depth after an automatic depth change. The linger time allows the fisherman to set the delay time after when fish are no longer detected before the weight 1 is returned to the selected depth according to one of the aforementioned depth setting routines. For example, as a minimum, the fisherman may want to provide a few second delay (depending upon the length of line 11 between the bait 13 and the weight 1) to ensure the bait 13 passes over, through or under detected fish before the weight 1 is returned to the normal operating depth. As another example, the fisherman may want the weight 1 to linger at the fish-following depth for a few minutes, such as long enough to conduct a turn to pass back over the detected fish. Again, the fisherman may enter the linger time value by keying in a number on the key pad 245 or on a touch screen display, or using a pointing device to select or indicate a desired time, and then pressing an “enter” or “select” key or icon.

After the fish-follow offset depth and linger time have been entered, the menu routine may then display another menu screen, such as a screen 544 asking whether to implement the GPS-waypoint depth routine, which is described below. Alternatively, the menu routine may jump to a routine in which the GPS waypoint depth option is offered in a menu screen 550.

If the entered response to the fish-follow menu option 540 was negative (i.e., the option was not selected), then a GPS waypoint depth option may be offered in a menu screen 550. This step gives the fisherman an option to initiate the GPS-waypoint depth routine. If the response to the GPS-waypoint depth menu option 544 is negative (i.e., the option was not selected), then the menu routine returns to the main loop, step 560, after which a normal operations screen may be generated and displayed by the main loop.

If the response to the GPS-waypoint depth option menu screens 544 or 550 is affirmative, then the menu routine may display a menu screen to prompt the fisherman to enter GPS points, step 551. Preferably, a number of GPS points and associated trolling depths may be stored and selected for monitoring. In step 551, the fisherman may select one or more stored GPS points to be monitored by pressing keys, touching icons on a touch screen or selecting icons (e.g., radio buttons) using a pointing devices. Thus, in step 551, a menu screen or screens may be displayed identifying all of the GPS points stored in memory 204 so that the fisherman can quickly select a subset (or all) of the points to be monitored.

Additionally, step 551 may permit the fisherman to select an option to enter new GPS waypoints, such as by pressing a key or touching or pointing to an icon on the display. If this option is selected, then a submenu or entry screen (which may also be part of the display provided in step 551) prompts the fisherman to enter the waypoint GPS coordinates (e.g., in latitude and longitude). Again, this information may be input via a keypad 245, by touching a touch screen, or making indications with a pointing device. In the embodiments in which the downrigger components and functions are integrated with a GPS receiver, particularly systems providing marine chart displays, the GPS coordinates may be entered in step 552 by touching a touch screen or pointing and clicking with a pointing device to indicate a location on a marine chart, which prompts the system to recognize the location information, determine the corresponding coordinates and save the related data in memory 240.

Once the GPS coordinate information has been entered and saved to memory in step 552, a submenu or data entry screen may be presented in step 553 prompting the fisherman to enter the trolling depth to be associated with the GPS waypoint. As with other menu options, the trolling depth may be entered such as by pressing a key or touching or pointing to an icon on the display. Optionally, another submenu or data entry screen may be presented to prompt the fisherman to indicate the distance from each waypoint at which to move the weight 1 to the selected waypoint trolling depth. Following entry of the trolling depth information, a screen may be displayed in step 554 asking the fisherman if another GPS waypoint is to be entered. If the response to this inquiry is positive, the routine will return to step 551 to permit the fisherman to select the point and enter another GPS waypoint/depth combination. If the response to this inquiry is negative, the routine returns to the main menu, step 560, after which a normal operations screen may be generated and displayed by the main loop.

In another embodiment, each of the menu options may be displayed simultaneously on the display screen for selection by a key, touching a touch screen or a pointing device. When the fisherman is finished entering menu selections, an exit-menu key or icon may be selected to return to the normal operating display.

When the fixed operating depth option for setting the depth of the weight 1 is selected, the main loop may periodically call the routine illustrated in FIG. 6 for initially positioning and then maintaining the weight at the selected operating depth stored in memory 204. As a first step, the routine may test a flag in memory in step 601 to determine whether the depth setting routine has been preempted by another pending function. This step 601 will inhibit the depth setting operation if other, higher priority routines have been activated, such as activation of the up/down switch 310, activation of the “fish-on” routine, and activation of any responsive depth adjusting routines, such as the fish-follow or GPS-waypoint depth routines. This step 601 simplifies software development, but is optional, since the preemption function may be accomplished by structuring the software so that the fixed operating depth routine is not accessed when higher priority functions are implemented (e.g., performing step 412 before step 408 in FIG. 4 and bypassing step 408 if a responsive routine is implemented).

If the fixed operating depth routine is not preempted, the system may measure or receive data on the depth of the weight 1 in step 602, and then compare in step 603 the measured or received depth data with the selected depth stored in memory 204. In step 604, the difference between measured and selected depth determined in step 603 is used to adjust the depth of the weight 1. If the difference is zero (i.e., the difference is less than a threshold value), no control signal is sent to the drive assembly 7 and the routine returns to the main loop in step 613.

If the difference is greater than zero (i.e. greater than a threshold value), indicating the weight 1 is deeper than the selected depth stored in memory, then the routine performs step 605 sending a signal to the drive assembly 7 to cause the drive motor to turn the reel 5 in a direction that raises the weight 1. In an embodiment, the signal may identify the amount by which the weight 1 is to be raised (e.g., specifying the number of turns of the reel 5). In another embodiment, the signal generated in step 605 may direct the drive assembly 7 to begin raising the weight 1, such as by setting a flag in memory, while in subsequent passes through the routine the system measures the depth of the weight step 602 as it is raised and continues to signal in step 605 that the weight should be raised until the difference test, step 604, shows there is no difference (or the difference is less than a threshold value), at which point the system directs the drive assembly 7 to stop raising the weight. The routine may also send a signal in step 606 to the buzzer or enunciator to sound an “up” signal, such as a buzz, bell, tone or machine-generated voice to alert the fisherman that the downrigger is raising the weight. The routine then returns to the main loop in step 613.

If the difference is less than zero (i.e., less than a threshold value), indicating the weight 1 is shallower than the selected depth stored in memory, then the routine performs step 607 sending a signal to the drive assembly 7 to cause the drive motor 71 to turn the reel 5 in a direction that lowers the weight 1. In an embodiment, the signal may identify the amount by which the weight 1 is to be lowered (e.g., specifying the number of turns of the reel 5). In another embodiment, the signal generated in step 607 may direct the drive assembly 7 to begin raising the weight 1, such as by setting a flag in memory, while in subsequent passes through the routine the system measures the depth of the weight 1 step 602 as it is lowered and continues to signal that the weight should be lowered in step 607 until the difference test, step 604, shows the weight is at the proper depth, at which point the system directs the drive assembly 7 to stop raising the weight 1. The routine may also send a signal in step 608 to the buzzer or enunciator to sound a “down” signal, such as a buzz, bell, tone or machine-generated voice to alert the fisherman that the downrigger is lowering the weight 1. The routine then returns to the main loop in step 613.

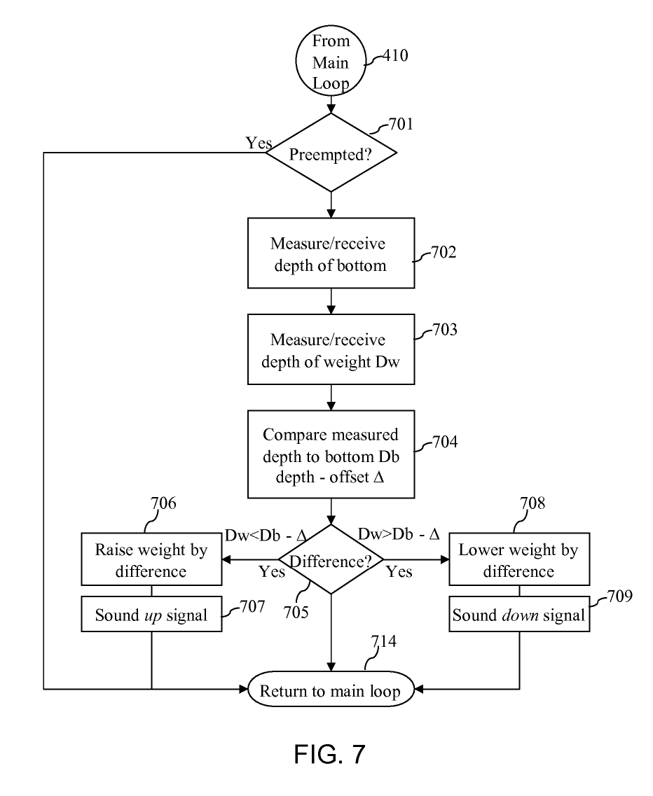

When the bottom following depth option is selected, the main loop will periodically call the bottom following routine such as the example illustrated in FIG. 7 for initially positioning and then maintaining the weight 1 at the selected offset above the bottom. As a first step, the routine may test a flag in memory in step 701 to determine whether the bottom following depth setting routine has been preempted by another pending function or routine. This step will inhibit the depth setting operation if other, higher priority routines have been activated, such as activation of the up/down switch 310, activation of the “fish-on” routine, and activation of any responsive depth adjusting routines, such as the fish-following or GPS-waypoint depth routines. As explained above, step 701 is optional, since the purpose of the preemption function may be accomplished other ways.

If the bottom following depth setting routine is not preempted, the system will measure or receive data on the depth of the bottom from the sonar/fish-finder system 230 in step 702 and the depth of the weight 1 in step 703. These depth measurements will be compared in conjunction with the user specified offset stored in memory 204 in step 704. This comparison may be accomplished by a simple mathematical addition and subtraction algorithm (e.g., Difference=Depth of Weight+Offset−Depth of Bottom). In step 705, the difference between the depth of the weight 1 plus the offset and the depth of the bottom determined in step 704 is used to adjust the depth of the weight 1. If the difference is zero (i.e., the difference is less than a threshold value), no control signal is sent to the drive assembly 7 and the routine returns to the main loop in step 714.

If the difference is greater than zero, indicating the weight 1 is deeper than the selected offset from the bottom, then the routine performs step 706 sending a signal to the drive assembly 7 to cause the drive motor 71 to turn the reel 5 in a direction that raises the weight 1. In an embodiment, the signal may identify the amount by which the weight 1 is to be raised (e.g., specifying the number of turns of the reel 5). In another embodiment, the signal generated in step 706 may direct the drive assembly 7 to begin raising the weight 1, such as by setting a flag in memory, while in subsequent passes through the routine the system measures the depth of the bottom and the weight 1 (steps 702 and 703) as it is raised and continues to signal in step 706 that the weight 1 should be raised until the difference test, step 705, shows there is no difference, at which point the system directs the drive assembly 7 to stop raising the weight 1. The routine may also send a signal in step 707 to the buzzer or enunciator to sound an “up” signal, such as a buzz, bell, tone or machine-generated voice to alert the fisherman that the downrigger is raising the weight. The routine then returns to the main loop in step 714.

If the difference is less than zero (i.e., the difference is less than a threshold value), indicating the weight 1 is shallower than the selected offset from the bottom, then the routine performs step 708 sending a signal to the drive assembly 7 to cause the drive motor 71 to turn the reel 5 in a direction that lowers the weight 1. In an embodiment, the signal may identify the amount by which the weight 1 is to be lowered (e.g., specifying the number of turns of the reel 5). In another embodiment, the signal generated in step 708 may direct the drive assembly 7 to begin lowering the weight 1, such as by setting a flag in memory, while in subsequent passes through the routine the system measures the depth of the bottom and the weight 1 (steps 702 and 703) as it is lowered and continues to signal in step 708 that the weight 1 should be lowered until the difference test, step 705, shows there is no difference, at which point the system directs the drive assembly 7 to stop lowering the weight 1. The routine may also send a signal in step 709 to the speaker 206 or enunciator to sound a “down” signal, such as a buzz, bell, tone or machine-generated voice to alert the fisherman that the downrigger is lowering the weight 1. The routine then returns to the main loop in step 714.

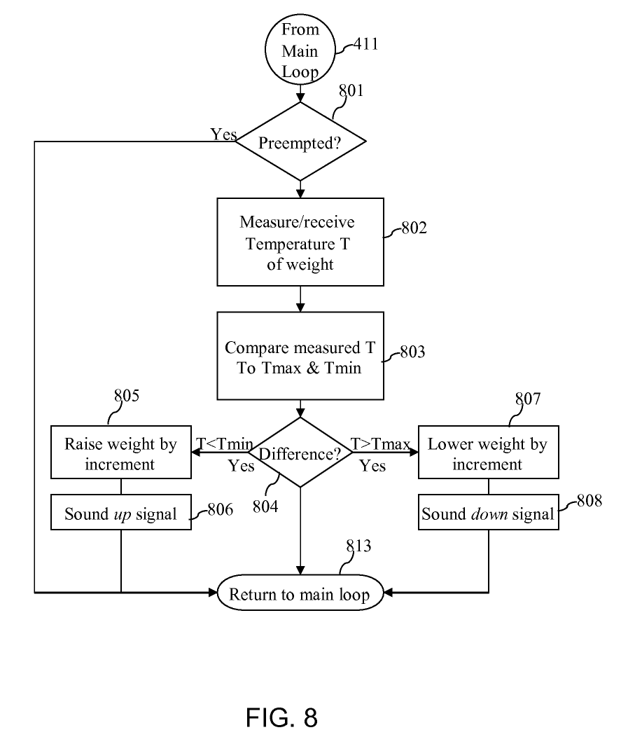

When the temperature profile following depth option for setting the depth of the weight 1 is selected, the main loop will periodically call the temperature following routine such as the example illustrated in FIG. 8 for initially positioning and then maintaining the weight 1 within the temperature profile (e.g., between maximum and minimum water temperatures) stored in memory 204. As a first step, the routine may test a flag in memory in step 801 to determine whether the temperature following depth setting routine has been preempted by another pending function or routine. This step will inhibit the depth setting operation if other, higher priority routines have been activated, such as activation of the up/down switch 310, activation of the “fish-on” routine, and activation of any responsive depth adjusting routines, such as in particular either the fish-following or GPS-waypoint depth routines. As explained above, the step 801 is optional, since the purpose of the preemption function may be accomplished other ways.

If the temperature following depth setting routine is not preempted, the system will measure or receive data on the temperature of the water at the depth of the weight 1 in step 802. The temperature measurement is compared with the user specified temperature profile stored in memory in step 803. Where water temperature decreases with depth, the temperature of the water measured at the weight 1 may be used to adjust the depth up or down in order to position the weight 1 within water of the desired temperatures, i.e., water temperatures which are expected to attract fish. The temperature profile may be entered and stored in the form of a minimum water temperature that the weight should stay out of (e.g., staying above such water temperatures), a maximum water temperature that the weight should stay out of (e.g., staying below such water temperatures), or maximum and minimum water temperatures that the weight should stay out of (i.e., to remain at depths where water is between these two temperatures). Assuming that water temperature decreases with increasing depth, the comparison between the measured water temperature and the stored temperature profile performed in step 804 may be used in combination with a simple algorithm to direct the drive assembly 7 to raise or lower the weight in order to stay within the selected temperature profile. An example of a simple difference algorithm is illustrated in FIG. 8. According to this algorithm, if the measured temperature is less than the preselected minimum temperature, then in step 805 the processor 201 may send a signal to the drive assembly 7 to begin raising the weight 1. In an embodiment, the signal sent in step 805 may cause the drive assembly 7 to begin raising the weight 1 until a stop signal is received, which will be sent in a subsequent loop through the temperature following routine when the difference measure, step 804, indicates the measured temperature is equal to or greater than the selected minimum temperature. In another embodiment, the signal sent in step 805 may cause the drive assembly 7 to raise the weight 1 by a predetermined increment, such as one foot. This increment may be set in software or selected by a fisherman using a menu screen similar to that used to enter the desired fishing temperature profile. If the measured temperature is greater than the preselected maximum temperature, then in step 805 the processor 201 may send a signal to the drive assembly 7 to begin lowering the weight 1. In an embodiment, the signal sent in step 805 may cause the drive assembly 7 to begin lowering the weight 1 until a stop signal is received, which will be sent in a subsequent loop through the temperature following routine when the difference measure, step 804, indicates the measured temperature to be equal to or less than the selected maximum temperature. In another embodiment, the signal sent in step 805 may cause the drive assembly 7 to lower the weight 1 by a predetermined increment, such as one foot. Again, this increment may be set in software or selected by a fisherman using a menu screen. In an embodiment, the processor may also send a signal to sound an “up” alarm, step 806, or “down” alarm, step 808, as appropriate. The routine then returns to the main loop in step 813.

Since the temperature of water may not decrease with depth, such as in the presence of a thermocline or temperature inversion, and fish may gather along nonlinear temperature profiles, more complex algorithms may be used in step 804 for determining the appropriate up/down/hold signal to be provided to the drive assembly 7. For example, a temperature profile map (i.e., a temperature vs. depth assay) may first be obtained and then stored in memory for use in step 804. As another example, the temperature measured at each depth (e.g., the temperature measured in each performance of step 802) may be stored in memory along with the corresponding depth of the weight and used to map the water temperature profile or to recognize and react to a nonlinear temperature profile.

An algorithm for determining depth control commands in the presence of temperature inversions may compare measured temperatures and depths per the procedures outline below, and recognize when the measured temperature increases with increasing depth or decreases with decreasing depth. Upon recognizing that this inverse relationship between depth and temperature exists, the processor 201 may then execute an alternative depth adjusting method, such as simply reversing the rules applied in step 805 until the measured temperature satisfies the preselected temperature criterion. Alternatively, if a temperature inversion is determined, the processor may command drive assembly 7 to move the weight 1 up or down by a predetermined increment in an attempt to move the weight 1 above or below the temperature inversion.

A method for positioning the weight 1 in the vicinity of inversion layers or thermoclines using a measured (or otherwise obtained) temperature profile may include a step of performing a memory table look-up using temperature as the independent variable to identify a depth or depths to which the weight 1 should be moved. In this method, if the result of the comparison in step 805 indicates the measured temperature at the weight 1 is either greater than the maximum temperature or less than the minimum temperature, then the processor can use the exceeded temperature profile limit (i.e., either the maximum or minimum temperature) as a look-up value in a table of the measured temperature profile stored in memory to determine the associated depth corresponding to a desired temperature (e.g., a temperature between the preselected maximum and minimum temperatures). For example, in a table look up routine, the processor 201 can compare the measured temperature to water temperature values stored in memory until a close match is identified (i.e., the measured value differs from a stored value by less than a threshold value), and then use the associated depth value stored in memory to reposition the weight 1. In a variation of this method, the table look up routine may also determine the depth that is associated with the other temperature bound (either maximum or minimum temperature), and calculate a depth value that is the average of the depths associated with the maximum and minimum temperatures.

In each of these methods, the processor may store the measured temperature profile (i.e., temperature and corresponding depth) in order to create or update a temperature profile stored in memory 204. In this manner, the system can compensate for changing water temperature profiles while efficiently maintaining the weight 1 within the preselected temperature range.

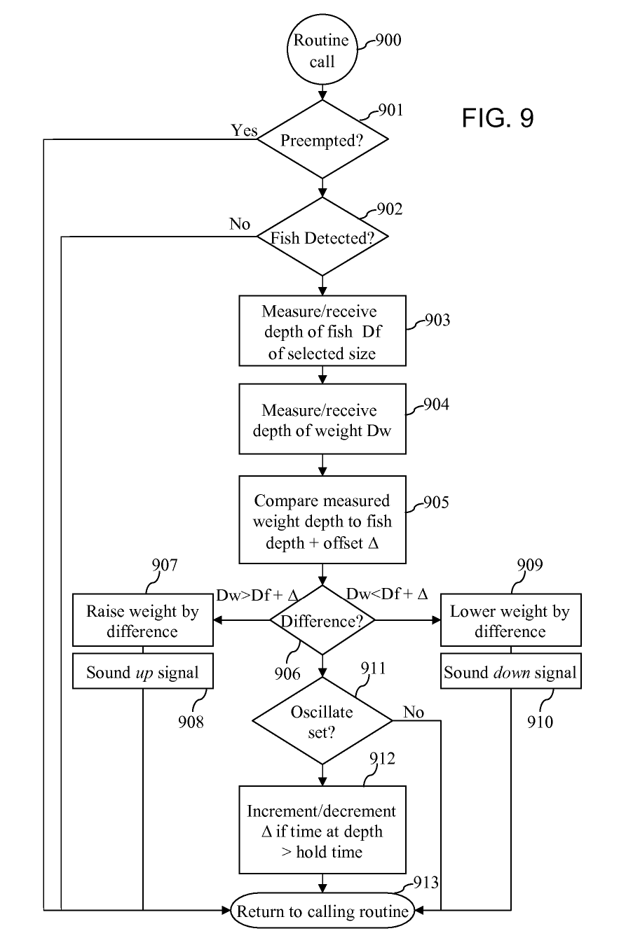

FIG. 9 illustrates an example embodiment for the fish-following responsive depth routine. This routine may be called from the main loop, step 900, in which case a first test, step 901, may be performed to determine if the routine has been preempted, such as by activation of a “fish on” flag in memory or activation of the up/down switch 310 by the fisherman. If the routine has been preempted, then the routine returns to the main loop in step 913.

If the fish-follow routine has not been preempted, then in step 902 a test may be performed to determine if fish have been detected by the sonar/fish finder system 230. If fish have been detected by the sonar/fish finder system 230, this condition may be indicated by storing a flag (e.g., a “1”) to memory 204 or setting a particular input to a predetermined voltage (e.g., +5 volts). As part of determining whether fish are detected, the sonar/fish finder system 230 may analyze the return echoes 34 to determine whether the fish are within a size selected by the fisherman for the fish follow routine. Alternatively, the sonar/fish finder system 230 may send data regarding the size or distribution of detected fish to the processor 201 to enable the processor to determine whether the detected fish satisfy criteria (e.g., size and/or number) set by the fisherman for initiating fish-follow depth changes.

If no fish satisfying the criteria for fish-following are detected, then the routine may simply return to the main loop in step 913.

If fish satisfying the criteria for fish-following are detected, then the processor 201 may perform step 903 to obtain from the sonar/fish finder system 230 (or from memory 204) the measured depth of fish satisfying the criteria (e.g., selected size). The processor may also perform step 904 to obtain (e.g., from memory 204) or measure the current depth of the weight 1. The fish depth measured in step 903 is then compared in step 905 to the weight depth measured or received in step 904. In this comparison, an offset value entered by the fisherman and stored in memory can be added to the fish depth measurement and the result subtracted from the weight depth to obtain a depth difference. Equivalent mathematical algorithms may be used as well, such as the offset value may be subtracted from the weight depth measurement before the depth measurements are subtracted.

In step 906, the depth difference determined in step 905 is used to determine whether a depth change command should be transmitted to the drive assembly 7. For example, if in step 905 the weight depth is greater (i.e., deeper) than the fish depth plus the offset by a threshold difference (i.e., a difference great enough to justify moving the weigh 1, a threshold which may be preselected by the fisherman in a data entry menu), then a command to raise the weight 1, step 907, may be sent by the processor 201 to the drive assembly 7. The command sent in step 907 may be to raise the weight by the difference determined in 905 or by some other increment. The processor may also send a command to sound the “up” signal, step 908, to alert the fisherman. If, on the other hand, the weight depth is less (i.e., shallower) than the fish depth plus the offset by a threshold difference, then a command to lower the weight 1, step 909, may be sent by the processor 201. The command sent in step 909 may be to lower the weight by the difference determined in 905 or by some other increment. The processor may also send a command to sound the “down” signal, step 910, to alert the fisherman. After either the up or down commands have been sent, the routine may return to the main loop in step 913.

If in step 906 the depth difference is approximately zero, or more specifically less than a threshold difference for initiate fish following depth changes, then the routine may return to the main loop, step 913, or initiate other actions appropriate when fish have been detected in the vicinity of the weight 1. For example, the weight 1 could be oscillated up and down in order to add additional motion to the bait or lure. In an embodiment, the fisherman may select, using an options menu, whether the weight should be oscillated, a selection which may be stored by setting a flag in memory 204. This memory flag may be tested in step 910, and if set, then an oscillating movement may be triggered, step 912. In such an oscillating routine, the weight 1 may be raised by an increment (e.g., a foot or two), held for a few seconds (the value of which may be preselected in a menu routine), and then lowered by an increment. To accomplish this, in step 912 the weight 1 may be raised or lowered by an increment amount (“Δ”) and a clock started. In subsequent passes through the routine illustrated in FIG. 9, the clock can be tested to determine if the hold time has expired, and if it has, the weight 1 lowered by an increment amount if the weight 1 had previously been raised, or raised if the weight 1 had previously been lowered. After step 912, the routine may return to the main loop in step 912.

Instead of or in addition to oscillating the weight in step 912 other actions may be initiated to help attract fish. As discussed more fully herein, one action may be to send a signal to a mechanism in the weight 1 to release a fish attracting scent. Such actions may be initiated as part of or in addition to step 912 shown in FIG. 9.

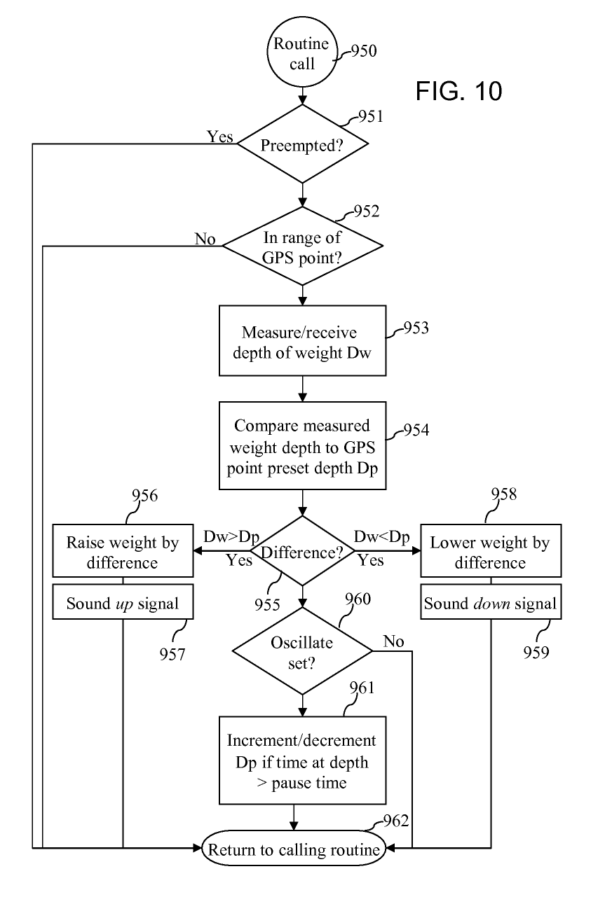

FIG. 10 illustrates an example embodiment for the GPS way-point responsive depth routine. This routine may be called from the main loop, step 950, in which case a first test, step 951, may be performed to determine if the routine has been preempted, such as by activation of a “fish on” flag in memory or activation of the up/down switch 310 by the fisherman. If the routine has been preempted, then the routine returns to the main loop in step 962.

If the GPS way-point responsive depth routine has not been preempted, then in step 952 the system obtains the current coordinates from the GPS receiver 235 (or recalls them from memory) and compares the current GPS coordinates to way-point coordinates stored in memory 204 to determine if the boat is currently within a threshold range of a stored way-point. The threshold range difference may be preselected by the fisherman in a menu option as a fixed range (e.g., 100 feet) for all waypoints or a range specific for each way-point stored in memory 204. If the current GPS coordinates are not within the threshold range of any waypoint in memory 204, then the routine returns to the main loop in step 962.

If the test in step 952 indicates the boat 9 is within range of a GPS way-point, then in step 953 the depth of the weight 1 is measured or obtained (e.g., recalled from memory), and the result compared in step 954 to the depth stored in memory 204 for the corresponding GPS waypoint. This comparison may be a simple subtraction of the two values, which can be tested in step 955 to determine whether the weight should be raised or lowered. For example, if the comparison in step 954 indicates that the depth of the weight (Dw) is greater (i.e., deeper) than the depth stored in memory for the present GPS way-point (Dp) by a threshold value, then a signal to raise the weight by the difference may be sent to the drive assembly 7 in step 956. The processor 201 may also send a command to sound the “up” signal, step 957, to alert the fisherman. If, on the other hand, the weight depth is less (i.e., shallower) than the depth stored in memory 204 for the present GPS waypoint (Dp) by a threshold amount, then a signal to lower the weight by the difference may be sent to the drive assembly 7 in step 958. The processor may also send a command to sound the “down” signal, step 959, to alert the fisherman. After sending a depth adjustment signal and sounding an “up” or “down” signal, the routine returns to the main loop in step 962.

If in step 955 the depth difference is approximately zero (e.g., it has been moved to that depth in a previous pass through the routine) or the difference is less than a threshold difference for initiate GPS waypoint depth changes, then the routine may return to the main loop, step 962, or initiate other actions intended to attract fish. For example, the weight 1 could be oscillated up and down in order to add additional motion to the bait or lure. In an embodiment, the fisherman may select, using an options menu, whether the weight 1 should be oscillated, a selection which may be stored by setting a flag in memory 204. This memory flag may be tested in step 960, and if set, then an oscillating movement may be triggered, step 961. In such an oscillating routine, the weight 1 may be raised by an increment (e.g., a foot or two), held for a few seconds, and then lowered by an increment. To accomplish this, in step 961 the weight 1 may be raised or lowered by an increment amount (“Δ”) and a clock started. In subsequent passes through the routine illustrated in FIG. 10, the clock can be tested to determine if the hold time has expired, and if it has, the weight 1 lowered by an increment amount if the weight 1 had previously been raised, or raised if the weight 1 had previously been lowered. After step 961, the routine may return to the main loop in step 962.

Instead of or in addition to oscillating the weight 1 in step 961 other actions may be initiated to help attract fish. As discussed more fully herein, one action may be to send a signal to a mechanism in the weight 1 to release a fish attracting scent. Such actions may be initiated as part of or in addition to step 961 shown in FIG. 10.

The other fish attracting actions, steps 912 and 961, are illustrated as part of the fish follow and GPS waypoint responsive depth routines for exemplary purposes only. Alternatively, the other actions may be structured in software as a separate routine (e.g., comprising steps 960 and 961) that is called from the main loop (so such other actions can occur at any or all times) or from any one or all of the depth setting routines described herein.

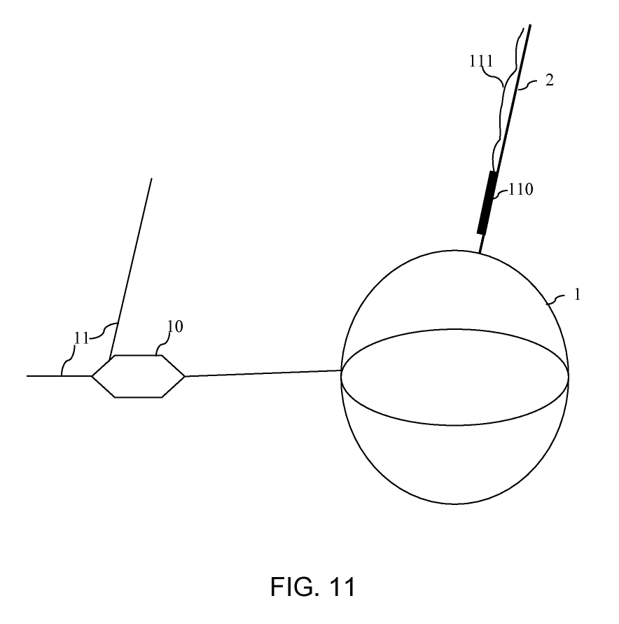

FIG. 11 illustrates details of the weight 1 assembly that can be implemented in order to support the depth setting methods described herein. In order to measure the temperature in the vicinity of the weight 1, a temperature measuring device 110 can be coupled to the suspension wire 2 or to the weight 1 itself. The temperature measuring sensor 1 may be any temperature sensor, such as a thermoresistor, thermocouple, or semiconductor-based temperature sensor. Signals from the temperature sensor 110 can be carried to the downrigger system by means of the suspension wire 2 or via a separate conductor 111. Additionally, as described above, the line clip 10 which holds the fishing line 11 may include a switch or sensor that detects when the fishing line has been removed, such as by the strike of a fish. Signals from the line sensor on or in the clip 10 can be carried to the downrigger system by means of the suspension wire 2 or via a separate conductor 111.

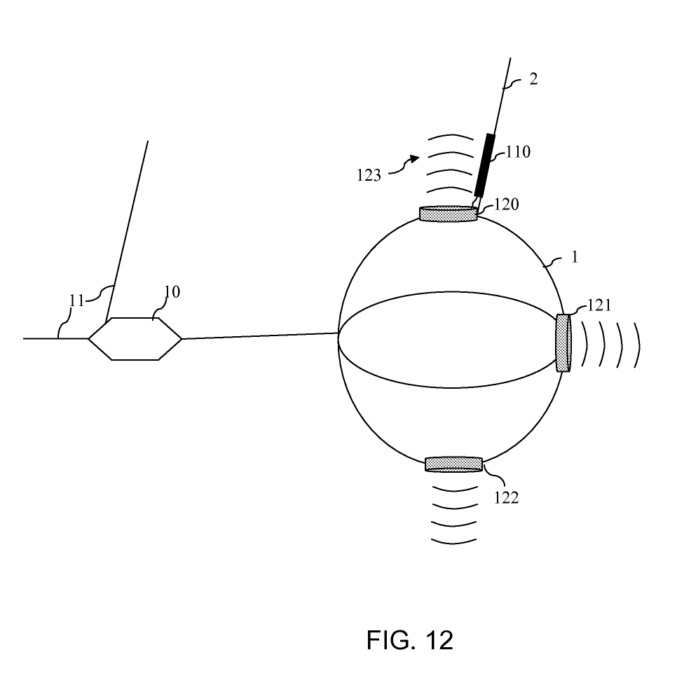

FIG. 12 illustrates another embodiment of the weight 1 which includes sonar transducers 120, 121, 122 coupled to the weight 1. Positioning sonar transducers 120, 121, 122 on the weight will provide the fisherman with additional information useful for locating and attracting fish. For example, a transducer 120 positioned on a top side (i.e., water surface-facing portion) of the weight 1 will provide an accurate measurement of the depth of the weight 1. As the weight 1 is pulled through the water during trolling, dynamic pressure from the water will cause the weight 1 to trail behind the boat and thus swing up to a depth less than indicated by the length of wire 2 that has been played out. Transducer 120 can be configured as a battery powered transponder so that it generates a sound pulse in response to receiving a sound pulse from the sonar/fish finder system 230, thereby providing a strong signal to permit accurate depth determination of the weight 1 by the sonar/fish finder system 230.

Transducer 120 may also (or alternatively) be configured to communicate data to the sonar/fish finder system 230 by means of frequency, pulse width or pulse waveform modulation of the transmitted sound 123. In an embodiment, the transducer 120 communicates the release of the fishing line 11 from the clip 10 as detected by the line sensor in the clip 10, thereby communicating a “fish on” condition to the downrigger assembly. In another embodiment, a temperature sensor 110 may be coupled to the transducer 120 to receive water temperature data, and the transducer configured to transmit the temperature data by encoding the data in the transmitted sound 123.

Any number of data encoding methods may be used to transmit data through the transmitted sound 123. For example, the temperature data may be communicated by varying the frequency of the transmitted sound 123, such that lower temperature data is communicated by transmitting lower frequency sound. As another example, the temperature data may be transmitted by sending the information in digital form by pulsing the transmitted sound 123 in a train of pulses, such as long pulses equal a “1” and short pulses equal a “0”, or two pulses equal a “1” and single pulses equal a “0”. As yet another example, digital data may be encoded by transmitting “1” bits at a first frequency and transmitting “0” bits at a second frequency higher or lower than the first frequency. More complicated data encoding methods may also be used, such as communicating two bits at a time by using four different frequencies to communicate each of bit patters “00”, “01”, “10” and “11”. Similarly, the sonar/fish finder system 230 can be configured to receive the transmitted sound 123 from the transducer 120 and decode the data by recognizing the data pattern and correlating the received signals to the corresponding digital data that can then be communicated to the processor 201. Since the aquatic environment is noisy, known methods for ensuring accurate transmission of data may be used, such as repeated transmission of the data and/or forward error correction coding methods well known in the data communication arts.

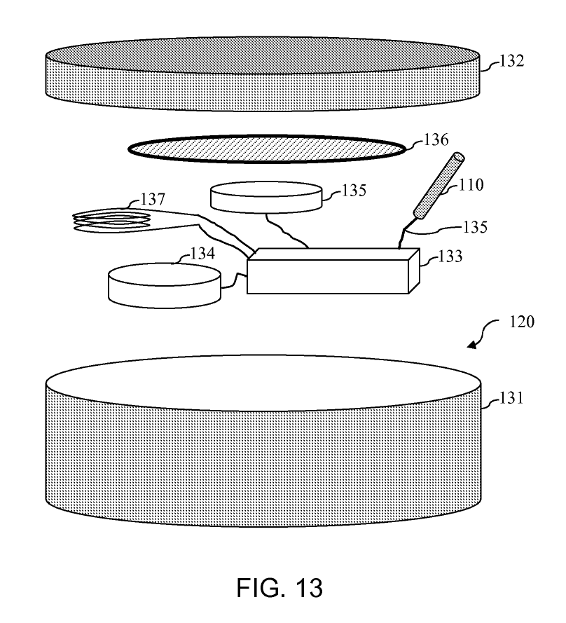

FIG. 13 is an exploded view of example components and construction suitable for transducers 120, 121, 122. The transducer assembly 120 can be encased in a water proof container 131 with a removable and sealable cover 132. Such a container 131 can be made from hardened plastic or metal with suitable strength to accommodate the water pressure at fishing depths. Alternatively, the container 131 may be made from deformable plastic so that water pressure is accommodated by deforming the walls of the container 131 while maintaining water tight integrity. Within the container 131 may be positioned control and signal generating electronics 133, electrically coupled to and powered by a battery 134, and electrically coupled to a piezoelectric transducer element 135. The electronics 133 can be a single chip or a chip set of integrated circuits preferably packaged in a water tight plastic or ceramic package. The battery 134 may be disposable, such as a conventional hearing aid or camera battery, but may be rechargeable. If rechargeable, the transducer assembly 120 may include an external electrical contact (not shown) for connecting to a recharger or an internal induction coil 137 coupled to the electronics 133 and configured for receiving power from an external radio frequency energy source as is well known in the electronic arts.

The electronics 133 send electrical signals, such as voltage pulses, to the piezoelectric element 135 which causes the element to change shape, thereby generating a mechanical pulse. Mechanical pulses from the piezoelectric element 135 can be coupled to water through the cap 132 directly, such as by placing the element 135 in physical contact with the cap 132. Alternatively, the piezoelectric element 135 can be mechanically coupled to a diaphragm or other sound enhancing structure, such as a metal disc 136 configured to provide a larger surface for transmitting sound and/or enhancing the coupling of sound waves between the piezoelectric element 135 and water.

In an embodiment, the transducer assembly 120 may include a temperature sensor 110 within or outside the container 131 configured to sense the water temperature and provide temperature information to the electronics 133 for transmission to the downrigger assembly or sonar/fish finder system 230 by any of the methods described above. Alternatively, an electrical lead 135 may extend through the container 131 for connection to an externally positioned temperature sensor 110, such as illustrated in FIG. 12. In another embodiment, the transducer assembly may include a pressure sensor (not shown) within or outside the container 131 configured to sense the water pressure (which is related to depth) and provide the pressure information to the electronics 133 for transmission to the downrigger assembly or sonar/fish finder system 230 by any of the data encoding methods described herein, so the downrigger processor 201 can calculate the depth of the transducer assembly 120.

The transducer assembly 120 is preferably configured as an inexpensive assembly by using low cost electronic circuits, commercially available piezoelectric elements 136, a commercially available battery 134 and a low cost container 131, all of which are configured for low cost, high volume production. Further, the transducer assembly 120 is preferably configured for easy attachment to the weight 1, such as by means of a threaded, latch or compression fitting or adhesive (e.g., an epoxy adhesive) so the transducers can be attached to any commercially available weight 1 and easily replaced when knocked off the weight 1.

Returning to FIG. 12, a forward looking (i.e., aligned with the direction of trolling) transducer 121 may be included on the weight 1 in order to provide a unique sonar perspective at the depth of the bait or lure. By facing the direction of trolling and at the depth of the bait, the transducer 121 can detect fish that will soon be passed and thus at a depth and position which may soon lead to a strike. In this embodiment, the downrigger assembly may provide an audible warning to alert the fisherman when the transducer 121 detects the impending passing of fish. The transducer 121 can be electronically linked to the downrigger assembly or sonar/fish finder system 230 on the boat via the suspension wire 2 or a separate connector (not shown but similar to connector 111 illustrated in FIG. 11). Alternatively, sonar data (e.g., distance and magnitude of received echo) may be communicated through transmitted sound 123 by the transducers 120 or 121 according to any of the data encoding methods described above.

A downward-facing transducer 122 may be coupled to the weight 1 in order to provide a more accurate measure of the distance between the weight 1 and the bottom for use in the bottom-following depth setting operation. Also, a downward-facing transducer 122 may be used as a second fish finder sensor for detecting and measuring the size of fish below the transducer. As with transducer 121, this transducer 122 can be electronically linked to the downrigger assembly or sonar/fish finder system 230 on the boat via the suspension wire 2 or a separate connector (not shown but similar to connector 111 illustrated in FIG. 11). Alternatively, sonar data (e.g., distance and magnitude of received echo) may be communicated through transmitted sound 123 by the transducer 120 according to any of the data encoding methods described above.

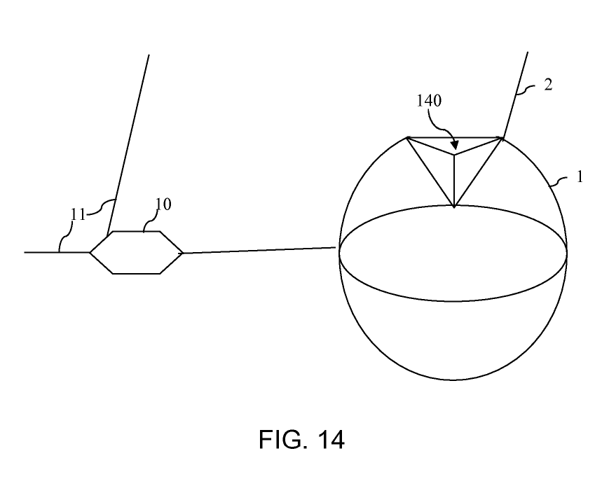

FIG. 14 illustrates an embodiment of the weight 1 suitable for use with various embodiments of the present invention. A retro-reflector cavity 140 is provided in a surface-facing portion of the weight 1. A retro-reflector is a tetrahedral or pyramidal shaped cavity providing interior reflecting surfaces oriented such that an incident wave entering the open portion of the cavity is reflected between cavity walls so that a reflected wave exits the cavity in a direction opposite to that of the incident wave. Providing a retro-reflector 140 on a top portion of the weight 1 increases the amplitude of reflected sonar wave from the weight 1 that reaches the sonar/fish finder transducer 31. A spherical weight 1 will tend to reflect some of the incident sonar pulse 32 away the transducer 31, and therefore may not return an echo with sufficient amplitude to permit accurate measurement of the depth of the weight 1. The retro-reflector cavity 140 may be empty (i.e., filed with water only). Alternatively, the retro-reflector cavity 140 may be filled with a polymer or plastic having a speed of sound comparable with that of water so the weight 1 has a smooth spherical surface to present minimum resistance to the water while trolling.

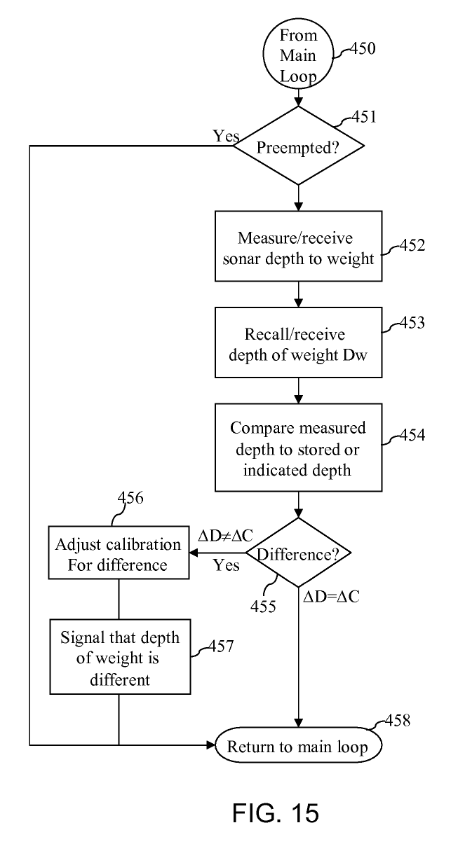

Providing a responding-transducer, i.e., sonar transponder 120, or a retro-reflector 140 on the top of the weight 1 facilitates measuring the depth to the weight 1 using the sonar/fish finder system 230. The downrigger assembly can use the directly measured depth to the weight 1 for the depth adjusting methods described above. Alternatively or additionally, the downrigger assembly can use the directly measured depth to the weight 1 to calibrate weight depth measuring mechanisms such as the number of turns of the reel 5. While counting the number of turns of the reel 5 provides an easy mechanism for estimating the depth of the weight 1, such a measurement can be distorted by the up-swing of the weight 1 due to dynamic pressure of water while trolling, uneven distribution of the wire 2 on the reel 5, the reducing circumference of the reel cylinder as wire 2 plays out, and stretch of the wire 2 itself. To compensate for such errors, the processor 201 may use periodic direct measurements of the weight's depth to calculate correction factors using methods such as in the example illustrated in FIG. 15. With such capability, an accurate depth adjustment movement can be achieved by the processor directing a certain number of turns of the reel 5.

Such a depth recalibration procedure may be called from the main loop, for example, in step 450. As with other methods, a condition flag may be tested initially in step 451 to determine whether the calibration routine has been preempted by other processes or states. If not preempted, then the processor 201 may cause the sonar/fish finder system 230 to measure and return (or retrieve from memory) the depth of the weight 1 in step 452, and recall from memory or receive from the downrigger assembly the indicated depth of the weight 1 in step 453. These two measured depths are compared in step 454, such as by subtraction. If the difference between these two measures exceeds a threshold value (e.g., 1 inch), then an adjustment to the depth calibration is made in step 456. For example, if the system determines the depth of the weight or raises/lowers the weight by a certain amount (such the amount signaled in any of steps 907, 909, 956 or 958, for example) by counting the number of turns of the reel 5, then the feet-per-unit-turn calibration factor can be adjusted in step 456.

If the amount of adjustment is significant, in other words it exceeds a large difference threshold, an alarm may be signaled in step 457 to inform the fisherman that the weight 1 is not at the expected or prior reported depth. This signal may also indicate to the fisherman the presence of fouling on the line 2 or weight 1 which has increased drag and thus caused the weight to swing up to a shallower than expected draft. Thus, the routine illustrated in FIG. 15 may also be used to detect and alert the fisherman to conditions that require attention since the weight 1 is not remaining at the expected depth based upon the amount of line 2 played out from the reel 5.

After an adjustment has been made to the depth calibration factor or the difference test 455 indicates no adjustment is required, the routine may return processing to the program from which it was called, such as the main loop, in step 458.

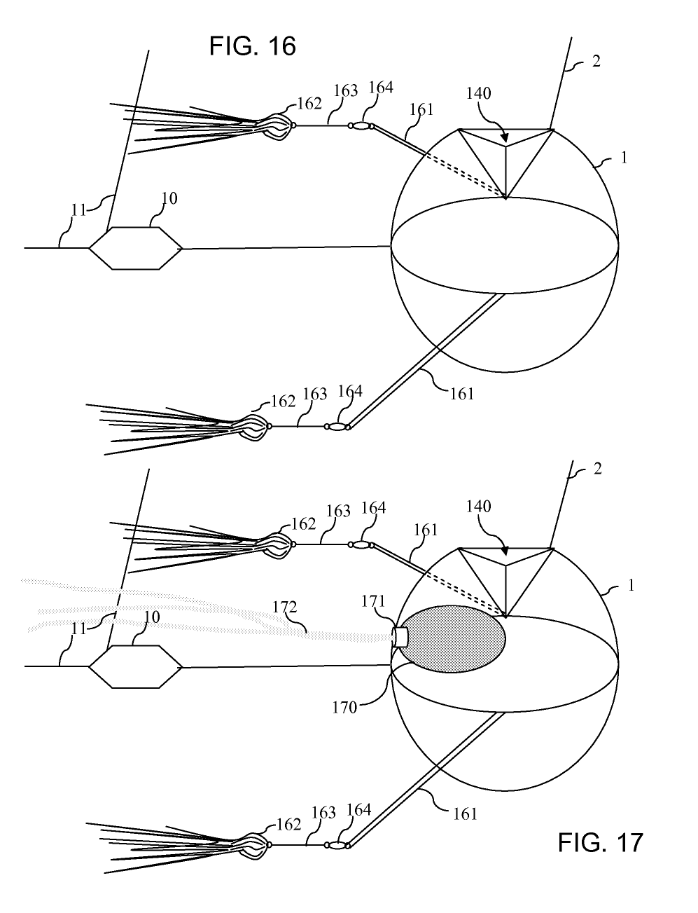

Since the various embodiments of the present invention place the weight 1 at depths where fish are expected or detected, fish attractor features may be added to the weight 1 to further attract fish to the bait or lure. FIG. 16 illustrates an embodiment of such a weight 1. In this embodiment, extensions or rods 161 are attached to or part of the weight 1 so as to position fish attractors 162 away from the fishing line 11. The fish attractors 162 may be any fish attracting lure, such as plastic, feather and/or buck tail streamers, spinners, spoons, or live or dead bait, preferably without hooks. A line 163 of variable length connected to each rod 161 permits positioning the fish attractors 162 at a desired distance ahead (i.e., in the direction of trolling) of the bait 13 or lure. A swivel 164 may be coupled between the rod 161 and the line 163 to allow free motion of the fish attractor 162. While FIG. 16 illustrates two rods 161 positioned on either side of the weight 1, any number of rods may be included in various orientations, such as three or four at equal angular orientation about the center of the weight 1. By using three or four fish attractors on the weight 1, the assembly may appear to fish as a small group of bait fish being followed by a straggler in the form of the bait or lure attached to the end of the fishing line 11.

In another embodiment illustrated in FIG. 17, the weight 1 can be provided with an internal or external cavity 170 for holding a fish attractant, such as fish oil, blood or chum. An opening or nozzle 171 limits the amount of fish attractant that enters the water behind the weight 1 so as to leave a scent plume 172 in the water which will encompass the bait or lure attached to the end of the fishing line 11. In an embodiment, the nozzle 171 can be activated electrically, such as a valve, diaphragm or movable vane so that release of the fish attractant can be controlled by the fisherman or automatically by the downrigger assembly. In an embodiment, the nozzle 171 is activated to release fish attractant when either of the fish-follow or GPS waypoint responsive depth setting routines are activated. In this way, fish attractant is released when fish are detected and the weight 1 is positioned at the appropriate depth, thereby conserving the attractant for when it can be most effective. In another embodiment, the nozzle 171 may be coupled to the transducer 121 positioned on the weight 1 and configured to release fish attractant when the transducer 121 detects fish in close proximity.

While the present invention has been disclosed with reference to certain preferred embodiments, numerous modifications, alterations, and changes to the described embodiments are possible without departing from the sphere and scope of the present invention, which is described, by way of example, in the appended numbered paragraphs below. Accordingly, it is intended that the present invention not be limited to the described embodiments, but that it have the full scope defined by the language of at least the following paragraphs, and equivalents thereof.

I claim:

1. A downrigger system, comprising:
a drive assembly coupled to a reel holding wire suitable for supporting a weight; and
a processor electronically coupled to the drive assembly and configured to receive data from a fish finder system and provide drive commands to the drive assembly in response to detection of fish.

2. The downrigger system of claim 1, wherein the processor is further configured to provide drive commands to the drive assembly in response to bottom depth information received from the fish finder system.

3. The downrigger system of claim 1, wherein the processor is further configured to receive position data from a Global Positioning System (GPS) receiver and provide drive commands to the drive assembly in response to the received position data.

4. The downrigger system of claim 1, further comprising:
the weight; and
a water temperature sensor positioned near the weight, wherein the processor is configured to receive temperature data from the water temperature sensor and provide drive commands to the drive assembly in response to the received temperature data.

5. The downrigger system of claim 1, further comprising:
the weight;
a clip configured to hold a fishing line coupled to the weight;
and a line sensor coupled to the clip and configured to detect the fishing line in the clip and transmit a signal to the processor when the fishing line is no longer in the clip,
wherein the processor is further configured to provide a drive command to the drive assembly in response to the signal from the line sensor.

6. The downrigger system of claim 1, further comprising:
the weight; and
a transducer positioned on or near the weight and configured to send a signal to the processor wherein the processor is further configured to receive the signal from the transducer and provide a drive command to the drive assembly in response to the signal from the transducer.

7. The downrigger system of claim 6, wherein the transducer is a sonar sensor configured to detect fish in the proximity of the weight.

8. The downrigger system of claim 6, wherein the transducer is coupled to a temperature sensor and the signal sent by the transducer encodes temperature data.

9. A method of controlling a depth of a downrigger weight, comprising:
positioning the weight at a first depth; and
automatically repositioning the weight at a second depth upon detecting fish at a depth different from the first depth.

10. The method of claim 9, further comprising automatically positioning the weight at a third depth upon approaching a geographic waypoint for which the third depth has been selected in advance.

11. The method of claim 9, wherein positioning the weight at the first depth comprises:
measuring a depth of a bottom; and
automatically positioning the weight at a preselected distance above the bottom.

12. The method of claim 9, wherein positioning the weight at the first depth comprises:
measuring a temperature of water near the weight; and
automatically adjusting the depth of the weight until the measured temperature of water near the weight is approximately within a preselected profile.

13. A downrigger system, comprising:
a weight suspended on a wire coupled to a reel;
a drive assembly coupled to the reel and configured to turn the reel in response to control signals; and
a controller including a processor and a memory electronically coupled to the processor, the controller configured to receive data from an external sensor,
wherein the processor is programmed with executable instructions which cause the processor to perform the steps of:
automatically sending control signals to the drive assembly to position the weight at a first depth; and
automatically sending control signals to the drive assembly to reposition the weight at a second depth based upon data received from the external sensor.

14. The downrigger system of claim 13, wherein the external sensor is a sonar and the processor is programmed to send control signals to the drive assembly to reposition the weight based upon fish detection data received from the sonar.

15. The downrigger system of claim 14, wherein the processor is further configured to receive data from a Global Positioning System (GPS) receiver and the processor is programmed to send control signals to the provide drive commands to the drive assembly in response to received position data.

16. The downrigger system of claim 14, wherein the processor is further configured to receive water temperature data and the processor is programmed to send control signals to the provide drive commands to the drive assembly in response to received water temperature data.

17. The downrigger system of claim 14, further comprising:
a display coupled to the processor; and
a data entry device coupled to the processor,
wherein the executable instructions cause the processor to display menu prompts on the display and to receive user inputs from the data entry device.

18. The downrigger system of claim 14, further comprising a speaker coupled to the processor, wherein the executable instructions cause the processor to generate sounds via the speaker upon sending control signals to the drive assembly to reposition the weight at a second depth.

19. The downrigger system of claim 13, further comprising a fish attractor coupled to the weight.

20. The downrigger system of claim 13, wherein the weight includes a container for dispensing a fish attractant.

21. The downrigger system of claim 14, wherein:
the weight includes one of a retroflector and a sonar transponder; and
the processor is further programmed determine a depth of the weight based upon echo data received from the sonar.
